(19) United States
(12) Patent Application Publication
(10) Pub. No.: US 2025/0183813 A1
(43) Pub. Date: Jun. 5, 2025

(54) CONNECTION MODULE FOR AN INVERTER CONTROL UNIT OF AN ELECTRIC MACHINE,CONNECTION SYSTEM FOR AN INVERTER CONTROL UNIT AND ELECTRIC DRIVE SYSTEM

(71) Applicant: SEG Automotive Germany GmbH, Stuttgart (DE)

(72) Inventors: Israel Lorite VILLALBA, Stuttgart (DE); Michael KOPP, Stuttgart (DE); Thomas HETSCHEL, Stuttgart (DE); Andreas WALTER, Stuttgart (DE); Martin FISCHER, Stuttgart (DE)

(21) Appl. No.: 18/966,333

(22) Filed: Dec. 3, 2024

(30) Foreign Application Priority Data
Dec. 4, 2023 (DE) 102023133880.3

(51) Int. Cl. H02M 7/00; H02P 27/06

(52) U.S. Cl. CPC H02M 7/003; H02P 27/06

(57) ABSTRACT

A connection module for an inverter control unit of an inverter of an electric machine has an input terminal connected to an external power supply source and an output terminal connected to a voltage supply terminal. A step-down converter between the input terminal and the output terminal includes an overvoltage protection circuit adapted to limit the input voltage to a predetermined maximum input level. The connection module also has a first communication port, a second communication port connected by communication lines so that data communication signals can be passed through the connection module. The converter circuit is arranged on a circuit board enclosed in a housing, the input terminal, the output terminal, and the first and second communications ports are provided in walls of the housing, the communication lines extend within the housing.

### CROSS-REFERENCE TO RELATED APPLICATIONS

This application claims priority to German Patent Application No. 10 2023 133 880.3 filed Dec. 4, 2023 which is hereby incorporated by reference in its entirety.

### TECHNICAL FIELD

The present disclosure relates to a connection module for an inverter control unit of an electric machine, a connection system for an inverter control unit and an electric drive system comprising an electric machine and the connection system.

### BACKGROUND

In (motor) vehicles, e.g. automobiles or trucks, electric machines can be used to drive the motor vehicle or, in the case of a hybrid vehicle, to drive it partially and/or intermittently. Electric machines can be operated both motor-driven (e.g. during acceleration processes of the motor vehicle) and generator-driven (e.g. during braking processes of the motor vehicle or to generate electricity). The voltage is applied to the windings of electric machines by means of a so-called “inverter” (power converter circuit), which is controlled by an inverter control unit. The inverter control unit receives, for example, information about a desired target value, e.g. target speed or target torque, from a higher-level control unit of the motor vehicle, such as a machine control unit or a vehicle control unit (VCU), and controls the electric machine accordingly. Electromagnetic interference in the voltage supply of the inverter control unit can lead to incorrect control of the inverter and thus the electric machine.

### SUMMARY

A connection module for an inverter control unit of an electric machine, a connection system for an inverter control unit and an electric drive system comprising an electric machine and the connection system with the features of the independent patent claims are proposed. Advantageous embodiments are the subject of the dependent claims and the following description.

One aspect of the disclosure relates to a connection module for an inverter control unit of an inverter of an electric machine. The connection module has an input terminal and an output terminal for DC voltage, wherein the input terminal can be connected to an external power supply source and the output terminal can be connected to a voltage supply terminal of the inverter control unit. The connection module further comprises a converter circuit which comprises a step-down converter or buck converter and which is adapted to convert an input voltage provided at the input terminal into a lower output voltage to be provided at the output terminal. The converter circuit comprises an overvoltage protection circuit which is adapted to limit the input voltage to a predetermined maximum input level. The connection module further comprises a first communication port, a second communication port and communication lines, wherein the first and second communication ports are connected by the communication lines so that data communication signals can be passed through the connection module. The connection module further comprises a housing, wherein the converter circuit is arranged on a circuit board enclosed in the housing, wherein the input terminal and the output terminal are provided in walls of the housing, wherein the communication lines extend within the housing, and wherein the first communication port and the second communication port are provided in the walls of the housing.

Such a connection module makes it possible to supply an inverter control unit with a suitable voltage level corresponding to the output voltage, whereby the inverter control unit is protected against electrical or electromagnetic interference by limiting the input voltage if necessary. The connection module can work as an adaptor for connecting an inverter control unit to a voltage network having a different voltage level.

Unless otherwise stated, the terms “connected”, “connectable” or similar are to be understood in the sense of electrically conductive connections.

According to at least one embodiment, the first and second communication ports and the communication lines are suitable for a CAN bus (Controller Area Network). A CAN bus is frequently implemented in vehicles, so that the connection module can advantageously use existing systems.

According to at least one embodiment, the connection module also has a safety circuit which is connected between the converter circuit and the output terminal and which is set up to limit the output voltage to a predetermined maximum output level. This allows the inverter control unit to be protected.

According to at least one embodiment, the safety circuit has a semiconductor switch and a switching controller which is set up to switch the semiconductor switch to the non-conductive state if the maximum output voltage is exceeded. This allows the inverter control unit to be protected.

According to at least one embodiment, the safety circuit is set up to implement short-circuit protection. This allows the inverter control unit to be protected.

According to at least one embodiment, the converter circuit and the safety circuit are arranged on the circuit board. This allows the size to be reduced.

According to at least one embodiment, the overvoltage protection circuit has at least one suppressor diode to limit the input voltage. This allows the overvoltage protection circuit to be protected.

According to at least one embodiment, the converter circuit has a filter circuit for suppressing electromagnetic interference, which is connected between the input terminal and the step-down converter. This allows the inverter control unit to be protected.

According to at least one embodiment, the filter circuit has inductors and capacitors that are suitably dimensioned in particular to meet electromagnetic compatibility (EMC) requirements. This allows the inverter control unit to be protected.

According to at least one embodiment, the converter circuit is set up to accept the input voltage in a range from 10 V to 32 V, in particular at around 24 V, and/or to provide the output voltage in a range from 6 V to 16 V, in particular at around 12 V. This means that an inverter control unit designed for operation in passenger cars with a conventional 12 V vehicle electrical system can be used in commercial vehicles with a higher vehicle electrical system voltage of 24 V, for example.

According to at least one embodiment, the maximum input level is in a range from 50 V to 70 V, in particular around 60 V, and/or the maximum output level is in a range from 12 V to 20 V, in particular around 16 V. This means that an inverter control unit designed for operation in passenger cars with a conventional 12 V vehicle electrical system can be used in commercial vehicles with a higher vehicle electrical system voltage of, for example, 48 V to 60 V.

According to at least one embodiment, the connection module has fastening means which are designed to mount the connection module securely to the inverter control unit or the electric machine, with the fastening means being arranged on the housing of the connection module. In this way, the connection module can be attached to the inverter control unit, in particular in such a way that it cannot be lost.

A further aspect of the disclosure relates to a connection system for an inverter control unit of an inverter of an electric machine, comprising a connection module. The connection module has an input terminal and an output terminal for DC voltage, wherein the input terminal can be connected to an external power supply source and the output terminal can be connected to a voltage supply terminal of the inverter control unit. Furthermore, the connection module has a converter circuit which has a step-down converter or buck converter and which is set up to convert an input voltage provided at the input terminal into a lower output voltage to be provided at the output terminal. The converter circuit has an overvoltage protection circuit which is set up to limit the input voltage to a predetermined maximum input level. Further, the connection module has a housing, wherein the converter circuit is arranged on a circuit board enclosed in the housing, the input terminal and the output terminal being provided in walls of the housing. The output terminal of the connection module is connectable to a power supply terminal of the inverter control unit. The connection system further comprises supply lines which are connected to the input terminal of the connection module and which can be connected to a power supply source.

According to at least one embodiment, the connection system has a connection module according to the disclosure. This makes it easy to achieve the advantages described above.

A further aspect of the disclosure relates to an electric drive system comprising an electric machine which is supplied with alternating voltages via an inverter, an inverter control unit for controlling the inverter, a power supply source, a machine control unit and a connection system according to the disclosure. The output terminal of the connection module is connected to a power supply terminal of the inverter control unit, wherein the second communication port of the connection module is connected to a data communication port of the inverter control unit, wherein the supply lines are connected to the power supply source, and wherein the control lines are connected to the machine control unit.

Further advantages and embodiments of the disclosure are shown in the description and the accompanying drawing.

The disclosure is illustrated schematically in the drawing by means of embodiment examples and is described below with reference to the drawing.

### BRIEF DESCRIPTION OF THE DRAWINGS

FIG. 1 shows an example of the structure of an electric drive system, which includes a connection module, in embodiments.

FIG. 2 shows the structure of a connection module, in embodiments.

FIG. 3 shows a circuit diagram of an step-down converter, in embodiments.

### DETAILED DESCRIPTION

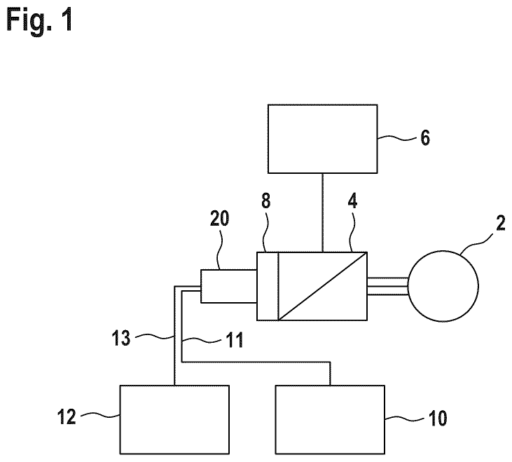

FIG. 1 shows a highly simplified illustration of the structure of an electric drive system that includes a connection module according to an embodiment.

The electric drive system has an electric machine 2 (e.g. a synchronous machine), the windings of which are supplied with alternating voltages by means of an inverter 4. The inverter 4 is, for example, connected to a battery, referred to as a traction battery 6, which provides a direct voltage in a low-voltage range (e.g. 12/24/1948 V) or a high-voltage range (e.g. in the range of several hundred to 1 to 2 kV), from which the alternating voltages are generated by suitable control of switching elements of the inverter 4. Alternatively or additionally, the inverter can also be connected to electrical consumers, e.g. via an on-board power supply. In regenerative mode, the traction battery and/or the consumers absorb the generated power. The switching elements are typically semiconductor switching elements, e.g. FETs, MOSFETs or IGBTs in half-bridge arrangements.

An inverter control unit 8 is provided, which generates control signals or control voltages at control inputs (gates) of the semiconductor switching elements of the inverter 4. The inverter control unit 8 has, for example, a computing unit, such as a microcontroller, integrated circuit, ASIC, etc., which is set up or programmed to implement a control or regulation method for the inverter. For example, the control signals for the semiconductor switching elements are determined by the inverter control unit 8 in such a way that a target value (e.g. target speed or target torque) is achieved or maintained by the electric machine. The target value can be specified by a higher-level machine control unit 10 of the machine or apparatus (e.g. vehicle) in which the electric drive system is used via a communication port, e.g. via a field bus, in particular a CAN bus (CAN: Controller Area Network), and transmitted to the inverter control unit 8, e.g. via control lines 11, which are connected to a data communication port of the inverter control unit 8.

The inverter control unit 8 is supplied with electrical energy from a battery 12 (power supply source or voltage supply source, e.g. so-called starter battery), which is independent of the traction battery 6, via supply lines 13, so that the inverter control unit 8 can be supplied with electrical power, in particular independently of the state of charge of the traction battery 6.

The battery 12 may have a certain voltage level, for example about 24 V in more modern applications or commercial vehicle applications, which is not suitable for the inverter control unit 8, which requires a conventional automotive supply voltage of about 12 V in order to control the semiconductor switching elements in particular.

In the environment in which the electric drive system is used, e.g. a motor vehicle or in particular a truck, electrical or electromagnetic interference can also occur, which can lead to voltage peaks, for example. Such electromagnetic interference can impair the function of the inverter control unit and, in extreme cases, lead to damage to the inverter, for example if semiconductor switching elements are not triggered correctly over time.

A connection module 20 is provided which, on the one hand, provides the appropriate voltage level for the inverter control unit 8 based on the voltage of the battery 12 and, on the other hand, suppresses voltage peaks. The use of the connection module makes it possible, in particular, to integrate an electric drive as an additional drive in an existing drive system, e.g. of a motor vehicle, in particular a truck, in which a battery with a voltage that is not suitable for the inverter control unit is present and no or few measures are provided to prevent electromagnetic interference.

Furthermore, it is preferable to route the control lines 11 together with the supply lines 13 in a common cable harness to the connection module 20. This allows the inverter control unit to be connected to the machine control unit 10 and the battery 20 via the connection module 20 in a simple manner, whereby little installation space is required and separate cable guides can be dispensed with.

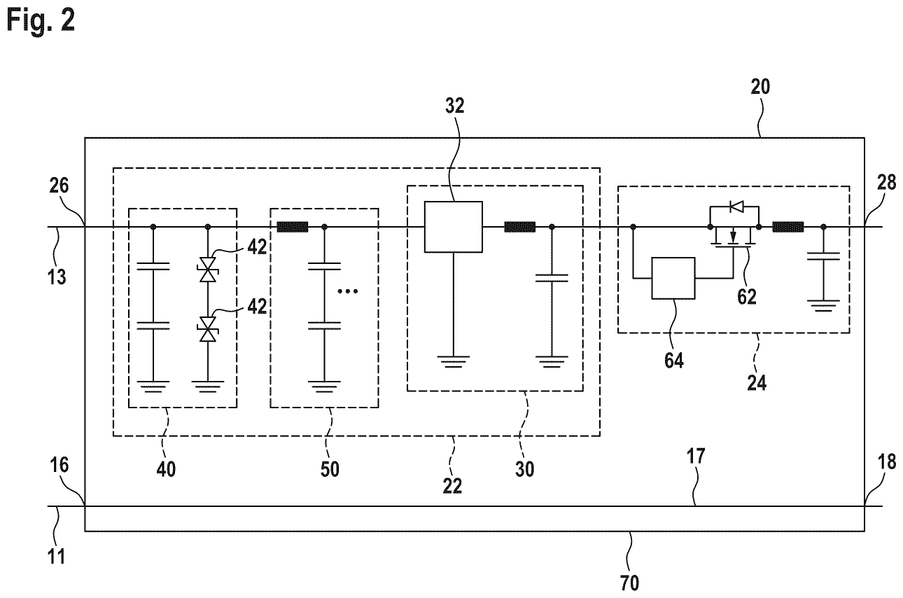

FIG. 2 shows (highly simplified) the basic structure of a connection module 20 according to an exemplary embodiment. The connection module 20 comprises a converter circuit 22 and optionally a safety circuit 24. Furthermore, the connection module 20 has an input terminal 26 and an output terminal 28. Clearly, the positioning, for example on a circuit board, of the converter circuit 22 and the safety circuit 24 or the elements by which these are constructed may differ from that shown, which serves in particular to illustrate the various functionalities. In addition to the illustrated elements of the converter circuit 22 and, if applicable, the safety circuit 24, further electrical elements, in particular passive elements (resistors, capacitors, inductors), which are not shown in the simplified representation of FIG. 2 and which are provided by the skilled person as required, can of course generally be provided.

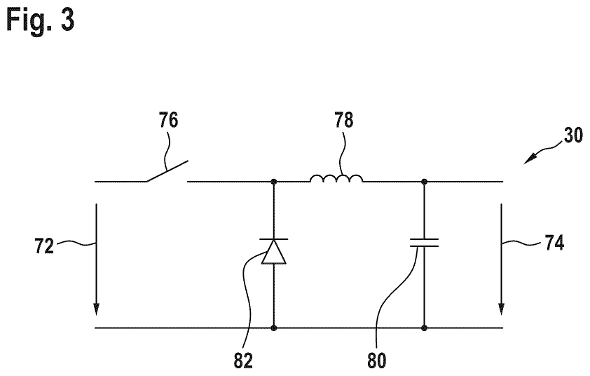

The converter circuit 22 has a step-down converter 30 (buck converter), as described, for example, in FIG. 3. A block 32 has active elements (in particular switches) and possibly a control circuit for controlling the active elements, and can be designed overall as a chip. The step-down converter 30 is configured to convert an input voltage, which is provided at the input terminal 26, into a lower output voltage, which is to be provided at the output terminal 28. In particular, the converter circuit 22 and/or its step-down converter 30 is configured to be suitable for an input voltage which lies or should lie in the range of 10 V to 32 V, for example is about 24 V. The converter circuit 22 or its step-down converter 30 is set up in particular so that it generates the output voltage such that lies or should lie in the range from 6 V to 16 V, e.g. about 12 V. The formulations “should lie” refer here to the fact that, for example, in the event of faults, the case may arise, at least briefly, that the respective voltage ranges are not maintained.

An overvoltage protection circuit 40 is provided on the input side, which is set up to limit the input voltage upwards to a predetermined maximum input level. The overvoltage protection circuit 40 can be regarded as part of the converter circuit 22. In particular, the overvoltage protection circuit 40 is connected between the input terminal 26 and the step-down converter 30, so that the voltage appearing at the input side of the step-down converter 30 is thus limited to the maximum input level. With reference to the above-mentioned range for the input voltage, the maximum input level may, for example, be in the range from 50 V to 70 V, in particular approximately 60 V. In particular, the overvoltage protection circuit 40 may comprise at least one capacitor and/or at least one suppressor diode 42 (two of which are shown as examples) in order to achieve the overvoltage protection function.

In addition, the converter circuit 22 may include a filter circuit 50 which is connected, for example, between the overvoltage protection circuit 40 and the step-down converter 30. The filter circuit 50 is designed to suppress electromagnetic interference. On the one hand, this relates to electromagnetic interference which acts on the converter circuit 22 or the connection module 20 from the outside and/or, on the other hand, to electromagnetic interference which emanates from the converter circuit 22 or the connection module 20 and could possibly affect other devices. The filter circuit 50 has, for example, suitably dimensioned inductors and capacitors (capacities).

The safety circuit 24 (if provided) is connected downstream of the converter circuit 22, i.e. is connected between the converter circuit 22 and the output terminal 28. The safety circuit 24 is adapted to limit the output voltage to a predetermined maximum output level. With reference to the above-mentioned range for the output voltage, the maximum output level may be in the range from 12 V to 20 V, for example, and may in particular be approximately 16 V. The safety circuit 24 can be realized by means of a semiconductor switching element, in particular by means of a MOSFET 62 (metal-oxide-semiconductor field-effect transistor), which is controlled by a switching controller 64, so that the semiconductor switching element 62 is switched to the non-conductive state when the maximum output level is reached or exceeded (e.g. the maximum output level is reached or exceeded). (e.g. the converter circuit 22 is connected to the output terminal 28 via the drain-source path of the MOSFET 62, and the gate terminal of the MOSFET is controlled accordingly by the switching controller 64).

The connection module 20, in particular the converter circuit 22, is preferably set up in such a way that the requirements according to the ISO 16750-2 (2012) standard are met. The connection module 20, in particular the safety circuit 24, is preferably set up in such a way that the requirements according to ASIL B (ASIL: Automotive Safety Integrity Level) or the ISO 126262 (2018) standard are met.

The input terminal 26 can be connected to a battery, in particular the battery 12. The output terminal 28 can be connected to a voltage supply connection of an inverter control unit. The connections can be made, for example, by plug connections, i.e. plugs or corresponding sockets are provided in each case, which have contacts, pins or the like for electrically conductive connection. The input terminal 26 and the output terminal 28 (which are shown here in simplified form) have at least two electrically conductive contacts, pins or the like, corresponding to the two voltage potentials provided by a power supply, one being provided for the supply voltage and the other for ground. In FIG. 1, only the electrical line for the supply voltage is shown in simplified form. Of course, a line for ground is also provided (not shown), which is connected to corresponding circuit elements (illustrated in the figure by earth symbols) and is routed through the connection module (to connect the earth contacts of the input terminal and the output terminal).

Furthermore, the connection module may have a first communication port 16, a second communication port 18 and communication lines 17. The communication lines 17 connect the first and second communication ports 16, 18 to each other so that data or data signals can be transmitted or transferred (i.e. looped through) from the first to the second communication port by the connection module. The second communication port 18 can be connected to a data communication port of the inverter. In particular, this enables the above-mentioned possible configuration in which control lines 11 are to be routed together with supply lines 13 in a common cable harness to the connection module 20. In particular, the first and second communication ports and the communication lines are suitable for a CAN bus. Depending on which bus or which system is used for data communication, the control lines 11 and the communication lines 17 (shown here in simplified form as a single line) have one or more signal lines or one or more wires; in the case of the CAN bus, for example, normally two (CAN_high, CAN_low). Accordingly, the first and the second communication port 16, 18 have one or more electrically conductive contacts, connection pins or the like, which are brought into electrically conductive connection with the wires by the respective connection. The supply lines 13 have two (or more) line wires, one for the supply voltage and one for the ground voltage (these line wires are connected to corresponding contacts, pins, or the like, which correspond to those of the input terminal 26).

The converter circuit 22 and the safety circuit 24, or the elements by which these are constructed, can in particular be arranged on a single circuit board. The circuit board is enclosed in a housing 70, with electrically conductive connections for the input terminal 26 and the output terminal 28 being provided in walls of the housing or led to the outside; for example in the form of plug connections.

Similarly, the first communication port 16 and the second communication port 18 are provided in the walls of the housing 70 or may pass through the walls. The communication lines 17 run inside the housing 70, they may be provided on the circuit board or routed separately therefrom. The first communication port 16 and the input terminal 26 are preferably both arranged together on a first side surface of the housing 70. In particular, the first communication port 16 and the input terminal 26 are arranged in close proximity to each other or adjacent to each other, so that they are integrated in a single connection element (on the first side surface), for example a single plug connection. Accordingly, the supply lines 13 and the control lines 11 can be routed in a single cable harness, which can be connected to the connection element on the first side surface via a corresponding connection element.

Also, the second communication port 18 and the output terminal 28 may both be arranged together on a second side surface (in particular different from the first side surface). The connection module 20 or its housing, in which the converter circuit 22 and the safety circuit 24 or the elements by which these are constructed are enclosed (for example, as mentioned above, are arranged on a circuit board), can furthermore have fastening means or fastening elements which make it possible to fasten or mount the connection module to an inverter, for example by means of screw connections.

FIG. 3 shows a circuit diagram of an exemplary step-down converter 30. Step-down converters (such as the one shown) and their function are known to those skilled in the art.

The step-down converter 30 converts an input voltage 72 into a lower output voltage 74. The input voltage and the output voltage are applied between an upper line shown in the figure and a lower line shown in the figure. The lower of the lines shown corresponds, for example, to a ground line.

The step-down converter 30 comprises a switch 76 (e.g. a semiconductor switching element or a transistor), an inductance 78 (coil), a capacitance 80 (capacitor) and a diode 82, the output voltage 74 being the voltage across the capacitance 80. The switch 76 is alternately closed and opened (e.g., at a frequency in the range of 10 kHz to 10 MHz). When the switch 76 is closed, the current through the inductance 78 (with the load connected on the output side) increases so that the inductance 78 generates a voltage opposite to the original input voltage, resulting in the output voltage being less than the input voltage, or in a step-down conversion. When the switch 76 is closed, the inductance 78 discharges stored energy, whereby current flows via the load and the diode 82. Instead of the diode 82, an appropriately controlled semiconductor switching element can also be used. The output voltage 74 is smoothed by the capacitance 80.

What is claimed:

1. A connection module (20) for an inverter control unit (8) of an inverter (4) of an electric machine (2), comprising
an input terminal (26) and an output terminal (28) for DC voltage, the input terminal being connectable to an external power supply source (12) and the output terminal being connectable to a power supply terminal of the inverter control unit;
a converter circuit (22) which comprises a step-down converter (30) and which is adapted to convert an input voltage provided at the input terminal (26) into a lower output voltage to be provided at the output terminal (28), the converter circuit (22) comprising an overvoltage protection circuit (40) which is adapted to limit the input voltage to a predetermined maximum input level;
a first communication port (16), a second communication port (18) and communication lines (17), the first and second communication ports being connected by the communication lines so that data communication signals can be passed through the connection module; and
a housing (70), wherein the converter circuit (22) is arranged on a circuit board enclosed in the housing, wherein the input terminal (26) and the output terminal (28) are provided in walls of the housing, wherein the communication lines (17) extend within the housing, and wherein the first communication port and the second communication port are provided in the walls of the housing.

2. The connection module (20) according to claim 1, wherein the first and second communication ports and the communication lines are suitable for a CAN bus.

3. The connection module (20) according to claim 1, further comprising a safety circuit (24) which is connected between the converter circuit (22) and the output terminal (28) and which is set up to limit the output voltage to a predetermined maximum output level.

4. The connection module (20) according to claim 3, wherein the safety circuit (24) has a semiconductor switch (62) and a switching controller (64) which is set up to switch the semiconductor switch (62) to a non-conductive state when the maximum output voltage is exceeded.

5. The connection module (20) according to claim 3, wherein the safety circuit (24) is set up to implement short-circuit protection.

6. The connection module (20) according to claim 3, wherein the converter circuit (22) and the safety circuit (24) are arranged on the circuit board.

7. The connection module (20) according to claim 1, wherein the overvoltage protection circuit (40) comprises at least one suppressor diode (42) to limit the input voltage.

8. The connection module (20) according to claim 1, wherein the converter circuit (22) comprises an electromagnetic interference suppression filter circuit (50) connected between the input terminal (26) and the step-down converter (30).

9. The connection module (20) according to claim 8, wherein the filter circuit (50) has inductors and capacitors which are dimensioned in particular suitably to fulfill EMC requirements.

10. The connection module (20) according to claim 1, wherein the converter circuit (22) is set up to accept the input voltage in a range from 10 V to 32 V, in particular at approximately 24 V, and/or to provide the output voltage in a range from 6 V to 16 V, in particular at approximately 12 V.

11. The connection module (20) according to claim 1, wherein the maximum input level is in a range from 50 V to 70 V, in particular at about 60 V, and/or the maximum output level is in a range from 12 V to 20 V, in particular at about 16 V.

12. The connection module (20) according to claim 1, further comprising fastening means adapted to mount the connection module (20) firmly to the inverter control unit (8) or the electric machine (2); wherein the fastening means are arranged on the housing (70) of the connection module.

13. A connection system for an inverter control unit (8) of an inverter (4) of an electric machine (2), the connection system having a connection module (20), the connection module (20) comprising:
an input terminal (26) and an output terminal (28) for DC voltage, the input terminal being connectable to an external power supply source (12) and the output terminal being connectable to a power supply terminal of the inverter control unit;
converter circuit (22) comprising a step-down converter (30) and adapted to convert an input voltage provided at the input terminal (26) to a lower output voltage to be provided at the output terminal (28), the converter circuit (22) comprising an overvoltage protection circuit (40) adapted to limit the input voltage to a predetermined maximum input level; and
a housing (70), wherein the converter circuit (22) is arranged on a circuit board enclosed in the housing, the input terminal (26) and the output terminal (28) being provided in walls of the housing;
wherein the output terminal (28) of the connection module (20) is connectable to a power supply terminal of the inverter control unit (8); and
the connection system further comprising supply lines (13) which are connected to the input terminal (26) of the connection module and which can be connected to a power supply source (12).

14. The connection system according to claim 13,
the connection module comprising a first communication port (16), a second communication port (18) and communication lines (17), the first and second communication ports being connected by the communication lines so that data communication signals can be passed through the connection module;
wherein the second communication port (18) of the connection module (20) can be connected to a data communication port of the inverter control unit (8); further comprising control lines (11) which are connected to the first communication port (16) and which can be connected to a machine control unit (10), wherein the supply lines (13) and the control lines (11) are at least partially routed in a common cable harness.

15. An electric drive system comprising an electric machine (2) which is supplied with alternating voltages via an inverter (4), an inverter control unit (8) for controlling the inverter, a power supply source (12), a machine control unit (10) and the connection system according to claim 14,
wherein the output terminal (28) of the connection module (20) is connected to a voltage supply terminal of the inverter control unit,
wherein the second communication port (18) of the connection module (20) is connected to a data communication port of the inverter control unit,
wherein the supply lines (13) are connected to the power supply source (12), and
wherein the control lines (11) are connected to the machine control unit (10).
